(19) United States
(12) Patent Application Publication
(10) Pub. No.: US 2009/0190151 A1
(43) Pub. Date: Jul. 30, 2009

(54) IMAGE FORMING APPARATUS

(76) Inventor: Kumiko Ogino, Kizugawa-shi (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/355,142

(22) Filed: Jan. 16, 2009

(30) Foreign Application Priority Data
Jan. 25, 2008 (JP) 2008-015171

(51) Int. Cl. G06F 3/12

(52) U.S. Cl. 358/1.13

(57) ABSTRACT

An image forming apparatus is provided that presents information for a function relevant to an operation performed by a user using a waiting time. The image forming apparatus displays information relevant to the operation when a user directly operates a multifunctional apparatus to execute a job and includes a relevant information presenting portion that stores function information explaining the function relating to the setup information for executing the job in a storage portion, obtains the function information to be presented in association with the job from the storage portion to display if a processing amount of a job in execution is greater than a predetermined amount. A size of the processing amount of the job is determined depending on the number of sheets or copies to be printed.

### CROSS-NOTING PARAGRAPH

This Nonprovisional application claims priority under 35 U.S.C. §119(a) on Patent Application No. 2008-015171 filed in JAPAN on Jan. 25, 2008, the entire contents of which are hereby incorporated herein by references.

### FIELD OF THE INVENTION

The present invention relates to an image forming apparatus that presents information for a function relating to operation conducted by a user, which is preferably applied to a multifunctional peripheral having a plurality of functions such as a document reading function, a copying function, a printing function, and facsimile function.

### BACKGROUND OF THE INVENTION

Image forming apparatuses are known as facsimile apparatuses, copying apparatuses, printing apparatuses, document reading apparatuses, and multifunctional peripherals having these functions, and functions of these image forming apparatuses are dramatically increasing. As the functions increase, users increasingly encounter situations where how to use or how to operate functions is unclear. For assistance in such situations, a help function (guidance function) is provided to display explanations for functions on a displaying portion disposed on an operating panel (Japanese Laid-Open Patent Publication No. 2002-182529).

However, since such a help function (guidance function) gives guidance of a function selected by a user, if a user wants to know all the functions of the apparatus, the user must repeat the selection operation for each function, and since the operation becomes cumbersome as the number of functions of the apparatuses increases, it is problematic that a function necessary for acquiring a desired processing result may not easily be selected.

Demonstration display is generally held at the stores or the places where the apparatuses are located so as to let users see performances, new functions, etc., of apparatuses such as image forming apparatuses (Japanese Laid-Open Patent Publication No. 2007-189330).

However, although such demonstration display is effective in drawing attention to what functions are provided in the apparatus as a whole, it is not clearly known whether a more appropriate function exists for a function currently operated by a user.

If an image forming apparatus is driven to execute a large amount of processing, it takes a long time to finish the processing, and during that time a user has nothing to do, i.e., it causes a waiting time.

As more functions are combined and advanced in image forming apparatuses as above, it becomes problematic that users may not completely understand the functions and may not sufficiently utilize the functions of the image forming apparatuses.

### SUMMARY OF THE INVENTION

It is the object of the present invention to provide an image forming apparatus that presents information for a function relating to operation conducted by a user making use of a waiting time.

The image forming apparatus of the present invention has the following configuration.

An image forming apparatus displays information relevant to an operation when a user directly operates a multifunctional apparatus to execute a job and comprises a relevant information presenting portion that stores function information that describes the function relevant to the setup information for executing the job in a storage portion for each setup information, and obtains the function information to be presented in association with the job from the storage portion to display, if a processing amount of a job in execution is greater than a predetermined amount.

The relevant information presenting portion determines a size of the processing amount of the job depending on the number of sheets or copies to be printed, selects a still image if a size of the processing amount of the job is small, and otherwise selects a moving image to display.

The above mentioned function information is the function information to save paper sheets as compared to the job, the function information to reduce printing time as compared to the job, or the advanced function information as compared to the job, and function information that represents these pieces of function information using still images or moving images.

### BRIEF DESCRIPTION OF THE DRAWINGS

FIG. 1 is a block diagram of a configuration of an image forming apparatus according to an embodiment of the present invention;

FIG. 2 is a flowchart of a processing procedure of a relevant information presenting portion;

FIG. 3 is an example of function information (one-point advice) displayed when a user performs copying of a large number of copies in a normal process;

FIG. 4 is an example of function information (one-point advice) displayed when a user performs copying of a large number of sheets in a normal process; and

FIG. 5 is an example of function information (one-point advice) displayed when a user performs copying with the use of a special function processing (2-in-1 function).

### PREFERRED EMBODIMENT OF THE INVENTION

A preferred embodiment of the present invention will now be described referring to the drawings.

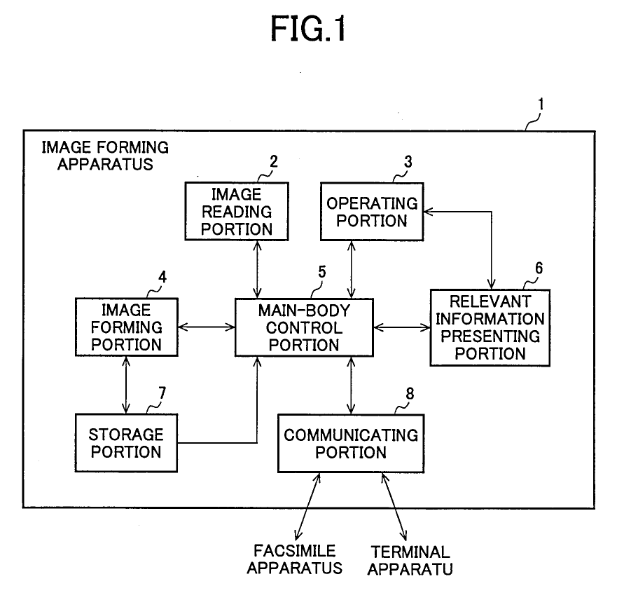

FIG. 1 is a block diagram of a configuration of an image forming apparatus according to the embodiment of the present invention. Although the image forming apparatus of the embodiment is described as a multifunctional peripheral capable of selectively executing a copying mode of reading and printing a document image onto a recording paper sheet, a printer mode of receiving and recording an image from a terminal apparatus onto a recording paper sheet, a scanner mode of reading and transmitting a document image to a terminal apparatus, and a facsimile mode of reading and transmitting a document image and receiving an printing a document image onto a recording paper sheet, the present invention is applicable to any multifunctional apparatuses.

The copying mode, the printer mode, the scanner mode, and the facsimile mode are hereinafter be referred to as function modes.

In FIG. 1, an image forming apparatus includes an image reading portion 2, an operating portion 3, an image forming portion 4, a main-body control portion 5, a relevant information presenting portion 6, a storage portion 7, and a communicating portion 8.

The operating portion 3 includes an input portion consisting of keys for setting each mode, system setting keys, ten-key, a clear key, a start key, etc., and a touch panel, and a displaying portion provided by overlapping the touch panel. Input instructions from the input portion are given to the main-body control portion 5. The displaying portion displays contents of inputs and processing in accordance with instructions from the main-body control portion 5 and the relevant information presenting portion 6.

The storage portion 7 stores information relating to the portions controlled by the main-body control portion 5, and the progressing state and the result of processing.

The storage portion 7 also stores the function information for describing functions relating to the setup information for executing a job by corresponding the function information to the setup information. The function information is data that describes functions relating to the setup information depending on various situations that a user sets when the user performs printing operations, and is preliminarily created using still images and moving images comprising characters, graphics, etc. It is assumed here that a reproduction time of moving images is longer than a reproduction time of a still image.

The main-body control portion 5 controls overall operations of the image forming apparatus 1 based on information relating to each portion stored in the storage portion 7. For example, the main-body control portion 5 monitors an input instruction from the input portion of the operating portion 3, executes any one of the various function modes properly in response to an input from an external terminal apparatus monitored through the communicating portion 8, and control the image reading portion 2, the image forming portion 4, the communicating portion 8, etc.

The main-body control portion 5 accurately displays the information relating to the status of the image forming apparatus 1 and the information should be given to a user on the displaying portion of the operating portion 3 when function mode is executed, and displays information relating to the input instructions on the displaying portion of the operating portion 3 through the relevant information presenting portion 6.

The image reading portion 2 reads a document image and stores image data representing this image in the storage portion 7. The image data stored in the storage portion 7 are sequentially read at appropriate timing and transferred to the image forming portion 4 in accordance with the processing contents instructed by the operating portion 3.

The image forming portion 4 properly executes various kinds of image processing for the image data transferred from the main-body control portion 5 and prints the image data on a recording paper sheet.

The communicating portion 8 gives and receives data between the image forming apparatus 1 and a terminal apparatus through a network or a telephone line network.

The above image forming apparatus 1 operates as follows according to the each functional mode:

In the copying mode, a document image is read by the image reading portion 2; the read image data are temporarily accumulated in the storage portion 7; and the image data are input to the image forming portion 4 and printed on a recording paper sheet by the image forming portion 4.

In the printer mode, image data are received from a terminal apparatus by the communicating portion 8 through a network, temporarily accumulated in the storage portion 7, and printed on a recording paper sheet in the same manner as the copying mode.

In the scanner mode, a document image is read by the image reading portion 2; the read image data are temporarily stored in the storage portion 7; and the image data are input to the communicating portion 8 and transmitted to a desired destination terminal apparatus from the communicating portion 8 through the network.

At the time of sending a call in facsimile mode, a document image is read by the image reading portion 2; the image data representing the image are temporarily stored in the storage portion 7; and the image data are input to the communicating portion 8 and transmitted to a desired destination terminal apparatus (facsimile apparatus) from the communicating portion 8 through a telephone line network.

At the time of receiving a call in facsimile mode, image data from a calling terminal apparatus (facsimile apparatus) are received and temporarily stored in the storage portion 7, and printed on a recording paper sheet in the same manner as the copying mode.

The relevant information presenting portion 6 will then be described.

When it is recognized that an input instruction that a user inputs operating the input portion of the operating portion 3 indicates a beginning of execution of processing for the image forming apparatus 1, the main-body control portion 5 controls to execute the processing that corresponds to the present function mode (any one of the copying mode, the printer mode, the scanner mode, and the facsimile mode) and, when the present function mode is the copying mode, the main-body control portion 5 sends to the relevant information presenting portion 6 various pieces of setup information set in accordance with this input instruction.

For example, if a user copies a document, the setup information relating to copying (such as the number of sheets, the number of copies, a scaling factor, color/monochrome copying, and reduced printing) is selected and input, and a key for starting the copying (a start key) is then pressed.

When the start key is pressed, the main-body control portion 5 sends the setup information relating to the copying that is set up by that point to the relevant information presenting portion 6.

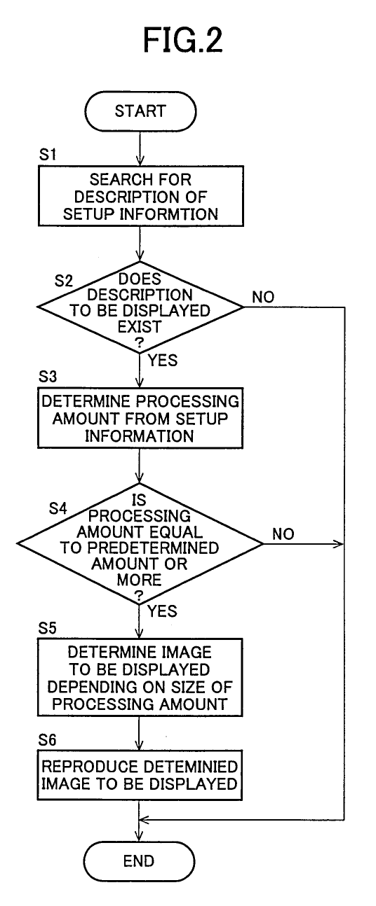

The relevant information presenting portion 6 receives the setup information from the main-body control portion 5 and executes a relevant information presenting processing shown in FIG. 2.

First, it is checked whether function information relevant to the received setup information is registered in the storage portion 7 (step S1).

If the relevant function information is not registered (step S2/NO), the relevant information presenting processing is terminated.

On the other hand, if the relevant function information is registered (step S2/YES), a processing amount is determined from the received setup information (step S3).

The processing amount is assumed to be the number of sheets or copies in the setup information.

The determined processing amount is smaller than a predetermined amount (step S4/NO), the relevant information presenting processing is terminated.

The processing amount is assumed to be the number of sheets or copies printable within a period of about 30 seconds to one minute.

On the other hand, if the determined processing amount is greater than the predetermined amount (step S4/YES), image data to be reproduced are determined in accordance with a size of the processing amount (step S5).

Selecting a still image or moving images is determined by a preset threshold value. For example, assuming the threshold value is 30 sheets or 30 copies, a still image is selected when the processing amount is smaller than the threshold value, on the other hand, moving images are selected when the processing amount is equal to the threshold value or more.

The selected image data are reproduced and displayed on the displaying portion of the operating portion 3 and are repeatedly reproduced until the processing of the specified function mode is completed (step S6). If the processing is completed in the middle of a repetition, the reproduction is terminated in accordance with the instruction from the main-body control portion 5 and the relevant information presenting processing is terminated.

The function information for the setup information will then be described.

(1) When a user makes a large number of copies in a normal processing:

If the number of copies is set equal to or greater than the predetermined amount as the setup information, the tandem function information for distributing and executing a print job among a plurality of multifunctional peripherals is displayed using a still image or moving images that notify a user of an advantage from the viewpoint of printing time.

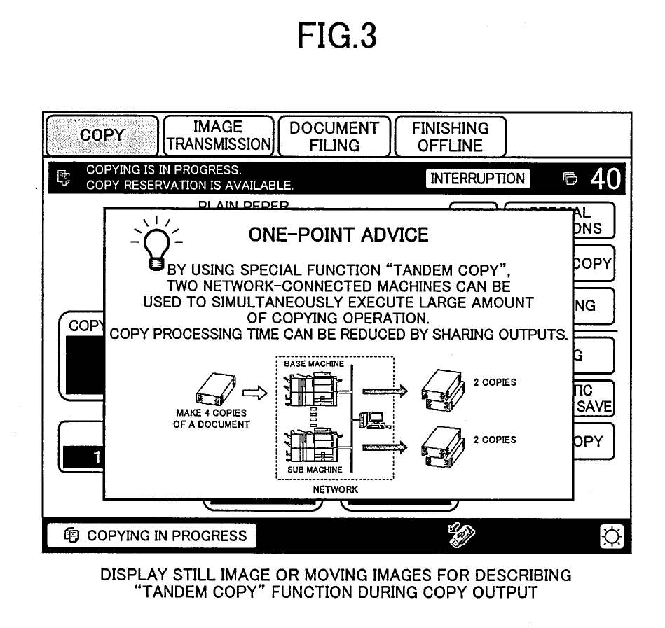

For example, when 30 copies are defined as a threshold value as shown in FIG. 3, if the number of copies is set to 40, the tandem function information is displayed using a moving image for one-point advice. On the other hand, if the number of copies is 25, the one-point advice is displayed using a still image.

(2) When a user makes a large number of sheets (or a large number of copies) in a normal processing:

If the number of printing sheets is set equal to or greater than the predetermined amount as the setup information, the function information relating to the reduced printing (such as 2-in-1 and 4-in-1) is displayed using a still image or moving images that notify a user of advantages from the viewpoints of printing time and cost.

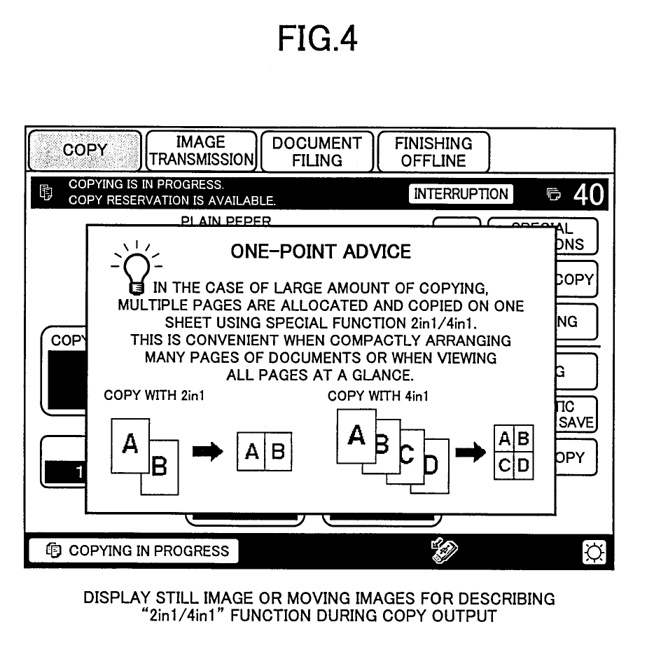

For example, when 30 sheets are defined as a threshold value as shown in FIG. 4, if the number of printing sheets is set to 40, the function description of the reduced printing is displayed using moving images for one-point advice. On the other hand, if the number of printing sheets is 25, the one-point advice is displayed using a still image.

Similarly, even when the number of documents is small, but a large number of copies are made, the function description of the reduced printing is displayed using moving images for the one-point advice. As a result, a user knows the reduced printing function and may use the reduced printing function when copying a plurality of documents from the next time.

(3) When a user makes a copy using a special function processing:

If the number of copies equal to or greater than the predetermined amount and the reduced printing (2-in-1) function for reducing and printing two documents on one sheet are set as the setup information, the function information of “saddle stitching” is displayed using a still image or moving images that notify a user of an advantage from the viewpoint of functionality.

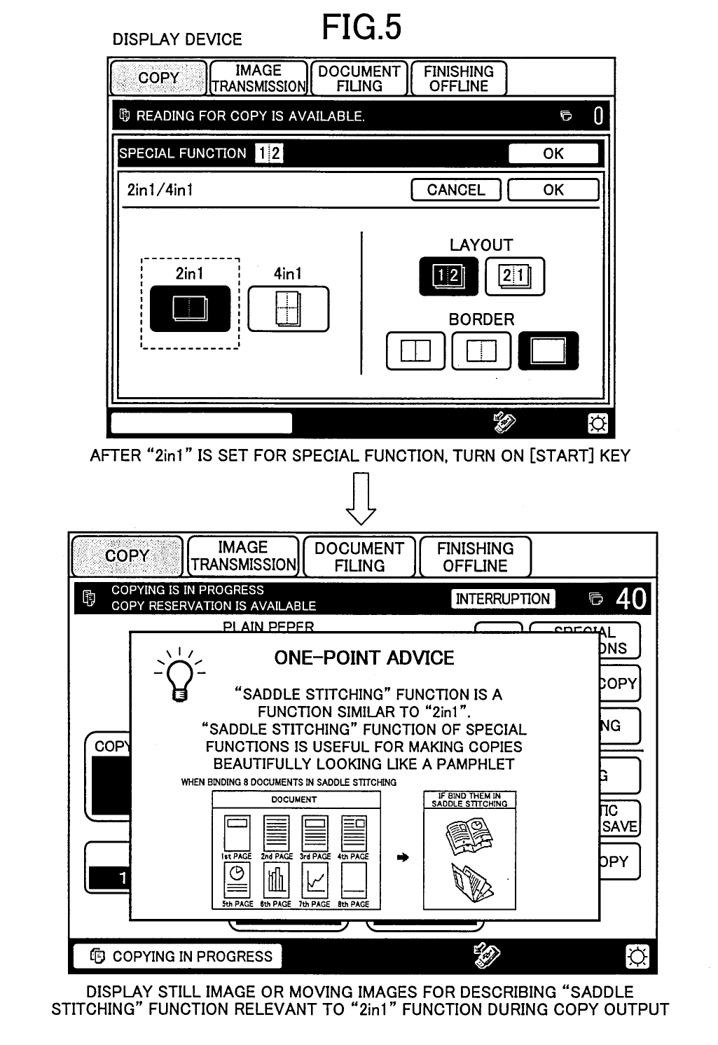

For example, as shown in FIG. 5, when 30 copies are defined as a threshold value, if the number of copies to be made is 30 and two or more documents are copied in the 2-in-1 function, the function description of the “saddle stitching” is displayed using moving images for one-point advice. On the other hand, if the number of copies to be made is 25, the one-point advice is displayed using a still image.

(4) Others:

Other than the above cases, this is also applicable in the case that the setup information is relating to the double-sided copying setting, the scaling function setting, the setting for a large number of sheets/copies, the function setting using a plurality of functions, etc.

For example, at the time of the double-sided copying setting, it may be displayed as the relevant information that a double-sided copying of an upside down image of a document can be made using a “double-sided copying direction switching function”.

At the time of the copying when the scaling function is set, it may be displayed as the relevant information that scaling factors can be set independently to the horizontal and vertical direction of the document using an “independent horizontal/vertical scaling function”.

At the time of the copying setting for a large number of sheets/copies, the one-point advice is displayed to indicate that it is convenient to use a “trial copying function” because one copy may be output in advance to check a copying result before continuing the copying regardless of the number of copies to be made.

At the time of the copying setting using five or more functions, the one-point advice is displayed to indicate that it is convenient to use a “job program function” because a registered copying setting may easily be called in a simple operation by using a job program having a function of combining various copying settings together when many settings are used for copying at one time.

Although the relevant function information is displayed only using images in the above embodiment, audio information and character information may also be held corresponding to images to reproduce sound and display characters in accordance with the images when displaying the relevant function information.

With the above configuration, even when a user is not familiarized to the functions of the image forming apparatus, the user may effectively make use of many functions of the image forming apparatus because it is possible to present the function information relevant to the operation executed by the user making use of a waiting time.

The present invention is not limited to the above embodiment and may obviously be altered or modified without departing from the gist of the present invention.

According to the present invention, the following effect may be obtained.

Even when a user is not familiar with the functions of the image forming apparatus, the user may effectively make use of many functions of the image forming apparatus because it is possible to present the function information relevant to the operation executed by the user making use of a waiting time.

1. An image forming apparatus displaying information relevant to an operation when a user directly operates a multifunctional apparatus to execute a job, wherein the image forming apparatus comprises a relevant information presenting portion that stores function information that describes the function relevant to the setup information for executing the job in a storage portion for each setup information, and obtains the function information to be presented in association with the job from the storage portion to display, if a processing amount of a job in execution is greater than a predetermined amount.

2. The image forming apparatus as defined in claim 1, wherein the contents of the function information to be presented are expressed by using a still image.

3. The image forming apparatus as defined in claim 1, wherein the contents of the function information to be presented are expressed by using moving images.

4. The image forming apparatus as defined in claim 1, wherein the relevant information presenting portion selects and displays either a still image or moving images depending on a size of the processing amount of the job.

5. The image forming apparatus as defined in claim 1, wherein the relevant information presenting portion determines a size of the processing amount of the job depending on the number of printing sheets.

6. The image forming apparatus as defined in claim 1, wherein the relevant information presenting portion determines a size of the processing amount of the job depending on the number of copies to be made.

7. The image forming apparatus as defined in claim 1, wherein the function information is function information to save paper sheets as compared to the job.

8. The image forming apparatus as defined in claim 1, wherein the function information is function information to reduce printing time as compared to the job.

9. The image forming apparatus as defined in claim 1, wherein the function information is advanced function information as compared to the job.
